(19) United States
(12) Patent Application Publication
(10) Pub. No.: US 2007/0064518 A1
(43) Pub. Date: Mar. 22, 2007

(54) System and method for controlling the release of pressurized fluid for concrete mixing

(76) Inventors: Bryan Howard Goff, Shepherdsville, KY (US); Max Scott Good, Frankfort, KY (US)

Correspondence Address: DINSMORE & SHOHL, LLP, 1900 CHEMED CENTER, 255 EAST FIFTH STREET, CINCINNATI, OH, 45202, US

(21) Appl. No.: 11/228,772

(22) Filed: Sep. 16, 2005

(51) Int. Cl. B28C 7/12; B28C 7/14

(52) U.S. Cl. 366/19; 366/53

(57) ABSTRACT

A system and method of controlling the release of pressurized fluid in a concrete mixer. Particularly, a system and method employing an electric switch mechanism within a cab portion of a vehicle to provide operator access to control the amount of water added to the mixing drum of the vehicle.

### TECHNICAL FIELD

The present invention relates generally to a system and method for controlling the release of pressurized fluid in a concrete mixer. Particularly, the system and method employ an electric switch mechanism within a cab portion of a vehicle to provide operator access to control the amount of water added to a mixing drum of the vehicle.

### BACKGROUND OF THE INVENTION

A key component of virtually every construction site is concrete production. Most sites utilize traditional concrete mixers to provide the requisite concrete for a work site. Because of such high demand for the production of concrete and the need for meeting deadlines on the construction site, it is very important that the concrete being produced meets requisite specifications. One common problem for concrete production can be the insufficient or overabundance of water added to the concrete mixture. Such a problem can cause the final concrete product to fail to meet the requisite standards necessary for use, and therefore, lead to waste and delays. A contributing factor for the insufficient or overabundance of water added to the concrete mixture can often be attributed to conventional water release mechanisms currently used on traditional concrete mixers. Traditional concrete mixers utilize a simple mechanical ball valve device that an operator can actuate from within the cab portion of the concrete mixer vehicle. The length of time that the operator allows the valve to be open can widely fluctuate and therefore lead to insufficient or an overabundance of water. Another existing problem is the mechanical ball valve located within the cab portion of the vehicle which can be easily and unintentionally actuated, thus leading to an improper amount of water being added to the concrete mixture, effectively destroying the usability and value of the final concrete product. This is not an uncommon occurrence with traditional concrete mixtures. For example, the location of the mechanical ball valve in the traditional concrete mixers is within arms reach of the operator's seat (generally to the left of the seat), such that the operator can easily reach the valve. However, having such a valve located in this manner leads to the problem of unintentionally adding water to the concrete mixture, thus, creating unusable concrete product.

### SUMMARY OF THE INVENTION

Accordingly, it is an object of the present invention to provide a system configured to be mounted on a vehicle for controlling the release of a pressurized fluid. It is a further object to provide a vehicle having a system for controlling the release of a pressurized fluid on a concrete mixer vehicle. It is yet another object to provide a method for controlling the release of a pressurized fluid on a vehicle.

In one exemplary embodiment, the invention is directed to a system configured to be mounted on a vehicle having a cab portion, a holding tank configured to contain a pressurized fluid and a mixing drum. The mixing drum and holding tank are operably connected by a conduit. The system includes an actuator assembly and an electric switch mechanism. The actuator assembly includes an actuating valve operably located in a conduit. The electric switch mechanism is configured to be operably accessible by an operator of the vehicle. The electric switch mechanism is located in a cab portion of the vehicle. The actuating valve is operable to receive a signal from the electric switch mechanism to open or close the actuating valve to control the release of a pressurized fluid from a holding tank to a mixing drum.

In another exemplary embodiment, the invention is directed to a vehicle having a cab portion, a holding tank, a mixing drum, an actuator assembly, and an electric switch mechanism. The holding tank is mounted on the vehicle and configured to contain a pressurized fluid. The mixing drum is mounted on the vehicle. The mixing drum and the holding tank are operably connected by a conduit. The actuator assembly includes an actuating valve operably located in the conduit. The electric switch mechanism is located in the cab portion of the vehicle and configured to be operably accessible by an operator of the vehicle. The actuating valve is operable to receive a signal from the electric switch mechanism to open or close the actuating valve to control the release of a pressurized fluid from the holding tank to the mixing drum.

In a further exemplary embodiment, the invention is directed to a method for controlling the release of a pressurized fluid on a vehicle. The vehicle includes a cab portion, a holding tank configured to contain the pressurized fluid and a mixing drum, the mixing drum and holding tank being operably connected by a conduit. The method includes actuating an electric switch mechanism and an actuator assembly. The electric switch mechanism is located in the cab portion of the vehicle and is operably accessible by an operator. The actuator assembly includes an actuating valve located in a conduit to open or close the actuating valve controlling the release of a pressurized fluid from a holding tank to a mixing drum.

The present system and method provide the operator with an electric switch mechanism which is located in the cab portion of the concrete mixer vehicle. The electric switch mechanism can be actuated to open or close a valve to provide for the release of pressurized fluid (e.g., water) from a holding tank mounted on the concrete mixer. This invention provides a solution to the existing problem with the current water release mechanism on concrete mixer vehicles. By utilizing a electric switch mechanism located in the cab portion, the operator will be able to more accurately add the appropriate amount of water to the mixing drum. Moreover, with an electric switch mechanism, the operator will be prevented from unintentionally actuating the valve and accidentally adding water to the concrete mixture, and destroying the final concrete product. This solution saves time and money, both highly valuable attributes in the construction industry. These and additional advantages of the present invention will be more readily apparent in view of the following detailed description.

### BRIEF DESCRIPTION OF THE DRAWINGS

While the specification concludes with claims particularly pointing out and distinctly claiming the present invention, it is believed that the same will be better understood from the following description taken in conjunction with the accompanied drawings in which:

FIG. 1 illustrates an exemplary embodiment of a concrete mixer vehicle having a cab portion, a holding tank and a mixing drum, the holding tank and mixing drum being mounted on the vehicle;

FIG. 2 depicts a flow chart illustrating an exemplary embodiment of the system and method for releasing pressurized fluid on a concrete mixer vehicle;

FIG. 3 illustrates an exemplary embodiment of a pneumatic actuating valve in-line with a conduit.

### DETAILED DESCRIPTION

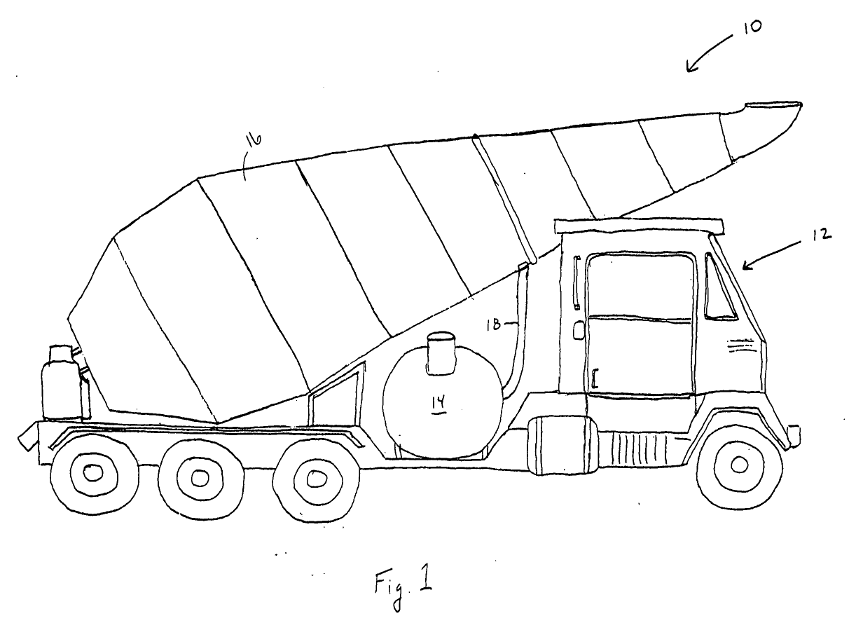

Exemplary embodiments of the present invention and its operation are hereinafter described in detail in connection with the views and examples of FIGS. 1-3, wherein like numbers indicate the same or corresponding elements throughout the views. As shown in FIG. 1, a vehicle 10 (e.g., concrete mixer) can have a cab portion 12, as well as a holding tank 14 and mixing drum 16 mounted on the vehicle 10. The vehicle 10 can be a front discharge concrete mixer like the embodiment illustrated in FIG. 1, but it is envisioned that the vehicle could also be a rear or side discharge concrete mixer. The cab portion 12 of the vehicle 10 effectively serves as the operating station for the release of the pressurized fluid. From the cab portion 12, the operator can actuate the release of the pressurized fluid from the holding tank 14 into the mixing drum 16. The holding tank 14 and the mixing drum 16 are operably connected by a conduit 18. In one exemplary embodiment, the conduit 18 can be a piping structure which is configured to operably contain the pressurized fluid as it flows from the holding tank 14 to the mixing drum 16. For example, the conduit 18 may be constructed from stainless steel piping or a PVC piping material that provides sufficient mechanical strength to contain the pressurized fluid. The holding tank 14 may also be constructed from a similar material (e.g., stainless steel, PVC) to provide for sufficient containment of the pressurized fluid. The fluid is pressurized when it is pumped into the holding tank 14 by the operator. The pressure contained in the holding tank 14 and the conduit 18 may range from about 40 psi to about 140 psi. The pressure is normally maintained at about 120 psi. The fluid remains pressurized in the holding tank 14 during the process of adding water to the mixing drum 16. The mixing drum 16 houses the batched concrete from the concrete plant prior to being retempered with the pressurized fluid (e.g., water), thus providing a concrete mixture which will ultimately form the final concrete product. The mixing drum 16 is configured to operably rotate along a mounted axis on the concrete mixer vehicle 10 providing the mechanism by which to continually mix the concrete mixture as water is added to retemper the system.

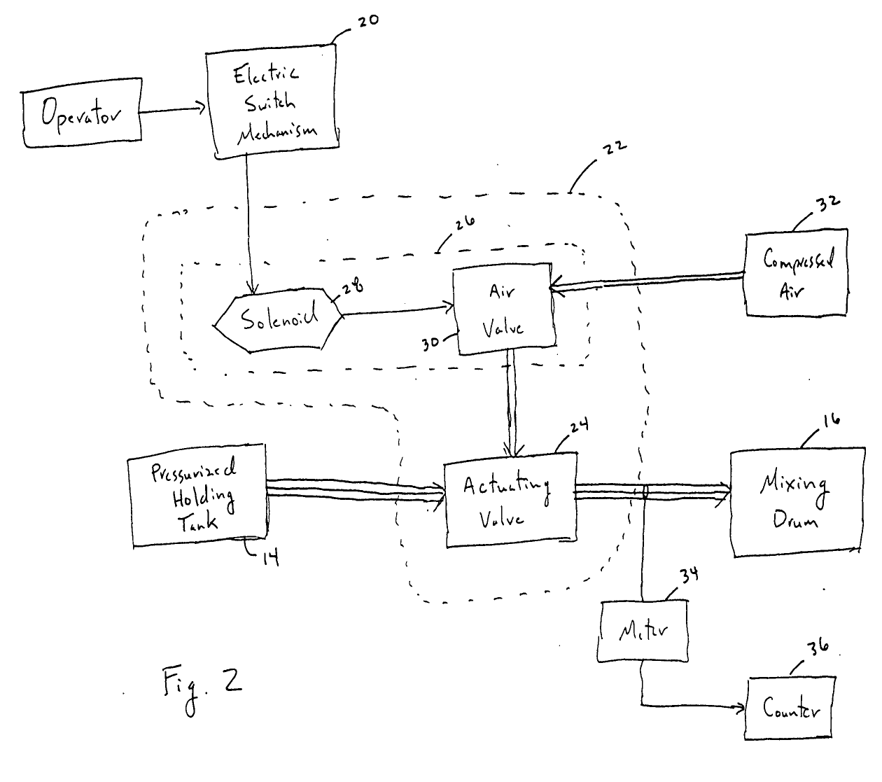

In order to begin the flow of water to the mixing drum 16, the operator can actuate an electronic switch mechanism 20 (as illustrated in FIG. 2) from within the cab portion 12 of the vehicle 10. Locating the electronic switch mechanism 20 in the cab portion 12 and proximate to the operator, makes it simple for the operator to add the pressurized fluid to the mixing drum 16. Traditional concrete mixers do not appear to employ such an electronic switch mechanism 20, but rather use a simple ball valve design which can be actuated from within the interior of the cab portion 12. This ball valve design however, is substantially flawed because it can easily be accidentally actuated by flipping the valve from one side to the other. This may occur unintentionally during daily use of the cab portion 12 of the concrete mixer vehicle 10 as the operator gets in or out of the cab portion 12. The ineffectiveness of this design can lead to an overabundance of water being added to the concrete mixture, which can destroy the value of the final concrete product.

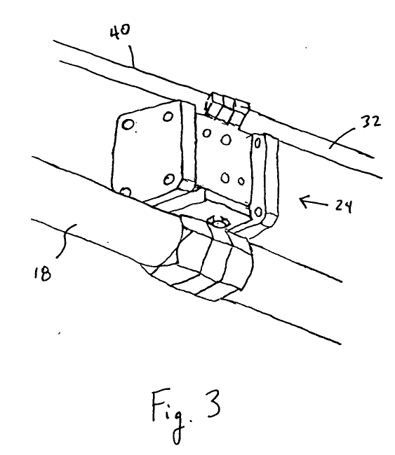

A flow chart has been provided in FIG. 2 to further illustrate one embodiment for the actuation of water addition to the mixing drum 16 from the holding tank 14. As illustrated in FIG. 2, the electric switch mechanism 20 is operably configured to be actuated by an operator. When the operator uses the electric switch mechanism 20, an actuator assembly 22 operably configured with the electric switch mechanism 20 is actuated. The actuator assembly 22 can be associated with the conduit 18 such that a portion of the actuator assembly 22 is operably tied into the conduit 18. As shown in FIG. 2, the actuator assembly 22 includes an actuating valve 24 (e.g., pneumatic actuating valve) which can be located within the conduit 18 between the holding tank 14 and the mixing drum 16. As depicted in the exemplary embodiment of FIG. 3, the actuating valve 24 is operably connected to the conduit 18. The actuating valve 24 can be operably opened or closed when it receives a signal originally sent by the electric switch mechanism 20.

As illustrated the exemplary embodiment of FIG. 2, the actuator assembly 22 further includes an air actuator 26. The air actuator 26 can be operably connected to compressed air 32 stored in the vehicle 10. The air actuator 26 can include the combination of a solenoid 28 and an associated air valve 30. The solenoid 28 instructs the air valve 30 to release a predetermined amount of air pressure (represented by a double arrow in FIG. 2) to actuate the actuating valve 24. When the electric switch mechanism 20 is actuated, a signal is sent to the solenoid 28 providing instructions to allow air pressure to pass through the air valve 30. The air pressure actuates and opens the actuating valve 24, thus the actuating valve 24 operates relative to the signal originally sent from the electric switch mechanism 20. This is also illustrated in FIG. 3 which shows that the actuating valve 24 is operably connected to an air line 40 from which the compressed air 32 passes from the air valve 30 to the actuating valve 24. If the electric switch mechanism 20 is in the “on” position, the solenoid 28 will operatively open the air valve 30 which will effectively open the actuating valve 24. When the electric switch mechanism 20 is in the “off” position, the solenoid 28 operably closes the air valve 30 and consequently closes the actuating valve 24. Moreover, the longer the actuating valve 24 is open, the larger the amount of pressurized fluid that passes from the holding tank 14 through the conduit 18 (represented by a triple arrow in FIG. 2) and enters the mixing drum 16. It is this increased control and flexibility that can allow the operator to effectively add the appropriate amount of water to the concrete mixture without upsetting the requisite specification of the final concrete product. One skilled in the art will appreciate that other constructions of actuator assemblies may be employed in place of the described actuator assembly 22. For example, the actuating valve can be an electric actuating valve, which can be driven directly by the electric switch mechanism instead of employing an air actuator.

In order to monitor how much water is added to the concrete mixture, a meter 34 can be utilized to track the flow of pressurized fluid into the mixing drum 16. The meter 34 may be located within or outside the cab portion 12. However, due to size limitations for the cab portion 12 and other potential problems in locating the meter 34 within the cab portion 12 of the vehicle 10, the meter 34 may be advantageously operably located outside of the cab portion 12. In one embodiment, the meter 34 can be in-line with the conduit 18, downstream of the actuating valve 24. If the operator will not be able to see the meter 34 from his location within the cab portion 12, a counter 36 associated with the meter 34 can be placed inside the cab portion 12 of the vehicle 10. The counter will provide the operator with the read out on the meter 34, informing the operator of the amount of water which has been added to the concrete mixture in the mixing drum 16. The counter 36 is operably connected to the meter 34, allowing the counter 36 to receive data signals and provide output displaying the amount of water passing through the actuating valve 24 and into the mixing drum 16.

The electric switch mechanism 20 itself can take on a variety of designs. One embodiment can include a simple two-way push button device. Such a switch allows the operator to actuate the button, and either continue to hold the button in the “on” position or have it lock in a fixed position. The operator can keep the button depressed until such time that the counter 36 associated with the meter 34 indicates the appropriate amount of pressurized fluid has been added to the mixing drum 16. The push button device can be locked or covered to prevent the operator from actuating the device. For example, a momentary push button or momentary normally-open push button could be used. Another exemplary embodiment provides for a three-way switch. Such a switch has an “off/on/off” configuration allowing additional flexibility for the operator when controlling the electric switch mechanism 20. Such a configuration allows the operator increased control when shutting off the water flowing to the mixing drum 16. In another exemplary embodiment, the electric switch mechanism 20 may include a dial which allows the operator to preselect a specific amount of water to add to the concrete mixture. The dial may also include a button that allows the operator to activate such a switch allowing the preselected amount of pressurized fluid to pass from the holding tank 14 through the conduit 18 into the mixing drum 16. In addition to the electric switch mechanism 20, any of other electrical switch mechanisms available or know to those in the art may also effectively be included in this design providing greater flexibility to the operator and eliminating the issue of accidentally switching open the valve and ruining the concrete mixture by providing an overabundance of water to the system.

While the invention has been so described in detail with reference to specific embodiments thereof, it will be apparent to those skilled in the art that various changes and modifications may be made therein without departing from the spirit of the invention, the scope of which is defined by the following claims.

We claim:

1. A system configured to be mounted on a vehicle, the vehicle having a cab portion, a holding tank configured to contain a pressurized fluid, and a mixing drum, the mixing drum and holding tank being operably connected by a conduit, the system comprises:
an actuator assembly comprising an actuating valve operably located in a conduit; and
an electric switch mechanism located in a cab portion of a vehicle and configured to be operably accessible by an operator of the vehicle, wherein the actuating valve is operable to receive a signal from the electric switch mechanism to open or close the actuating valve to control the release of a pressurized fluid from a holding tank to a mixing drum.

2. The system as recited in claim 1, wherein the actuator assembly comprises an air actuator.

3. The system as recited in claim 2, wherein the air actuator is operably connected to compressed air stored on the vehicle.

4. The system as recited in claim 1, wherein the actuating valve comprises a ball valve.

5. The system as recited in claim 1, wherein the electric switch mechanism comprises a push button mechanism.

6. The system as recited in claim 1, wherein the system further comprises a meter operably located in the conduit downstream of the actuating valve.

7. The system as recited in claim 6, wherein the meter monitors the amount of the pressurized fluid released from the holding tank to the mixing drum.

8. The system as recited in claim 6, wherein the system further comprises a counter associated with the meter, wherein the counter is located in the cab portion of the vehicle.

9. A vehicle comprising:
a cab portion;
a holding tank mounted on the vehicle configured to contain a pressurized fluid;
a mixing drum mounted on the vehicle, wherein the mixing drum and the holding tank are operably connected by a conduit;
an actuator assembly comprising an actuating valve operably located in the conduit; and
an electric switch mechanism located in the cab portion of a vehicle and configured to be operably accessible by an operator of the vehicle, wherein the actuating valve is operable to receive a signal from the electric switch mechanism to open or close the actuating valve to control the release of a pressurized fluid from the holding tank to the mixing drum.

10. The vehicle as recited in claim 9, wherein the vehicle is a ready-mix concrete mixer.

11. A method for controlling the release of a pressurized fluid on a vehicle, the vehicle having a cab portion, a holding tank configured to contain the pressurized fluid, and a mixing drum, the mixing drum and holding tank being operably connected by a conduit, the method comprising:
actuating an electric switch mechanism located in a cab portion of the vehicle operably accessible by an operator and an actuator assembly including an actuating valve located in a conduit to open or close the actuating valve controlling the release of pressurized fluid from a holding tank to a mixing drum.
